(19) United States
(12) Patent Application Publication
(10) Pub. No.: US 2025/0181890 A1
(43) Pub. Date: Jun. 5, 2025

(54) DETERMINING RECOMMENDATION INDICATOR OF RESOURCE INFORMATION

(71) Applicant: Tencent Technology (Shenzhen) Company Limited, Shenzhen (CN)

(72) Inventors: Ruobing XIE, Shenzhen (CN); Junjie HUANG, Shenzhen (CN); Shaoliang ZHANG, Shenzhen (CN); Feng XIA, Shenzhen (CN); Leyu LIN, Shenzhen (CN)

(73) Assignee: Tencent Technology (Shenzhen) Company Limited, Shenzhen, GD (CN)

(21) Appl. No.: 19/050,865

(22) Filed: Feb. 11, 2025

Related U.S. Application Data
(63) Continuation of application No. PCT/CN2023/130455, filed on Nov. 8, 2023.

(30) Foreign Application Priority Data
Jan. 17, 2023 (CN) 202310108533.0

(51) Int. Cl. G06N 3/042; G06N 3/045; G06N 3/0464

(52) U.S. Cl. CPC G06N 3/042; G06N 3/045; G06N 3/0464

(57) ABSTRACT

In a method for determining recommendation indicators, a first bipartite graph is constructed based on interaction feature data that indicate interactions between a plurality of objects and a plurality of pieces of resource information. A second bipartite graph is constructed based on the interaction feature data. Comprehensive embedding vector representations of the plurality of graph nodes are determined based on the first bipartite graph and the second bipartite graph. The recommendation indicator for each of the plurality of pieces of resource information with respect to each of the plurality of objects is determined based on the comprehensive embedding vector representation of the object node corresponds to the respective object and the comprehensive embedding vector representation of the resource information node corresponds to the respective piece of resource information. Apparatus and non-transitory computer-readable storage medium counterpart embodiments are also contemplated.

### RELATED APPLICATIONS

The present application is a continuation of International Application No. PCT/CN2023/130455, filed on Nov. 8, 2023, which claims priority to Chinese Patent Application No. 202310108533.0, filed on Jan. 17, 2023. The entire disclosures of the prior applications are hereby incorporated by reference.

### FIELD OF THE TECHNOLOGY

This application relates to the field of artificial intelligence technologies, including a method for determining a recommendation indicator of resource information.

### BACKGROUND OF THE DISCLOSURE

With the rapid development of artificial intelligence (AI) technologies, an intelligent recommendation system has been widely used in various fields in recent years, such as providing users with appropriate content in the fields such as e-commerce, advertising, and social media websites. In related art, the recommendation system usually adopts an “ignoring” or “blacklist” processing mechanism for negative feedback information (i.e., negative feedback information of a user on recommendation information). “Ignoring” means directly disregarding the negative feedback information of the user, and the blacklist processing mechanism means that the recommendation information for which a user has given a negative feedback will no longer be recommended to the user, resulting in low recommendation performance of the recommendation system.

### SUMMARY

Aspects of this disclosure include a method, an apparatus, and a non-transitory computer-readable storage medium for determining one or more recommendation indicators of resource information, which can improve recommendation performance of a recommendation system.

Examples of technical solutions of this disclosure may be implemented as follows:

An aspect of this disclosure provides a method for determining recommendation indicators. A first bipartite graph is constructed based on interaction feature data that indicate interactions between a plurality of objects and a plurality of pieces of resource information. The first bipartite graph includes (i) a plurality of graph nodes and (ii) a positive connecting edge. The plurality of graph nodes includes an object node for each of the plurality of objects and a resource information node for each of the plurality of pieces of the resource information. The positive connecting edge is between a first object node of the plurality of object nodes and a first resource information node of the plurality of resource information nodes. The positive connecting edge indicates a positive feedback feature between a first object of the plurality of objects that corresponds to the first object node and a first piece of resource information of the plurality of pieces of resource information that corresponds to the first resource information node. A second bipartite graph is constructed based on the interaction feature data. The second bipartite graph includes the plurality of graph nodes and a negative connecting edge between a second object node of the plurality of object nodes and a second resource information node of the plurality of resource information nodes. The negative connecting edge indicates a negative feedback feature between a second object of the plurality of objects that corresponds to the second object node and a second piece of resource information of the plurality of pieces of resource information that corresponds to the second resource information node. Comprehensive embedding vector representations of the plurality of graph nodes are determined based on the first bipartite graph and the second bipartite graph. The recommendation indicator for each of the plurality of pieces of resource information with respect to each of the plurality of objects is determined based on the comprehensive embedding vector representation of the object node corresponding to the respective object and the comprehensive embedding vector representation of the resource information node corresponding to the respective piece of resource information.

An aspect of this disclosure provides an apparatus. The apparatus includes processing circuitry configured to construct a first bipartite graph based on interaction feature data that indicate interactions between a plurality of objects and a plurality of pieces of resource information. The first bipartite graph includes (i) a plurality of graph nodes and (ii) a positive connecting edge. The plurality of graph nodes includes an object node for each of the plurality of objects and a resource information node for each of the plurality of pieces of the resource information. The positive connecting edge is between a first object node of the plurality of object nodes and a first resource information node of the plurality of resource information nodes. The positive connecting edge indicates a positive feedback feature between a first object of the plurality of objects that corresponds to the first object node and a first piece of resource information of the plurality of pieces of resource information that corresponds to the first resource information node. The processing circuitry is configured to construct a second bipartite graph based on the interaction feature data. The second bipartite graph includes the plurality of graph nodes and a negative connecting edge between a second object node of the plurality of object nodes and a second resource information node of the plurality of resource information nodes. The negative connecting edge indicates a negative feedback feature between a second object of the plurality of objects that corresponds to the second object node and a second piece of resource information of the plurality of pieces of resource information that corresponds to the second resource information node. The processing circuitry is configured to determine comprehensive embedding vector representations of the plurality of graph nodes based on the first bipartite graph and the second bipartite graph. The processing circuitry is configured to determine a recommendation indicator for each of the plurality of pieces of resource information with respect to each of the plurality of objects based on the comprehensive embedding vector representation of the object node corresponds to the respective object and the comprehensive embedding vector representation of the resource information node corresponds to the respective piece of resource information.

An aspect of this disclosure provides a non-transitory computer-readable storage medium storing instructions which when executed by a processor cause the processor to perform any of the methods of this disclosure.

In the aspects of this disclosure, the negative feedback information of the object for the resource information is not ignored or discarded, but the first bipartite graph and the second bipartite graph are respectively constructed by using the positive feedback information and the negative feedback information, then the comprehensive embedding vector representation of each graph node in the bipartite graph is determined, and then prediction of the recommendation indicator of each piece of resource information for each object is implemented based on the comprehensive embedding vector representation of each object node and the comprehensive embedding vector representation of each resource information node, so as to recommend the resource information to the object based on the recommendation indicator. In other words, in aspects of this disclosure, the positive feedback information and the negative feedback information of the objects for the resource information are comprehensively considered, so that the recommendation indicator of the resource information for the object can be more accurately determined, thereby improving accuracy of recommendation based on the recommendation indicator, and then improving the recommendation performance of the recommendation system.

### BRIEF DESCRIPTION OF THE DRAWINGS

FIG. 1 shows an implementation environment of a method for determining a recommendation indicator of resource information according to an aspect of this disclosure.

FIG. 2 shows operations of a method for determining a recommendation indicator of resource information according to an aspect of this disclosure.

FIG. 3 shows an example of a bipartite graph according to an aspect of this disclosure.

FIG. 4 shows an operation of obtaining a first embedding vector representation and a second embedding vector representation of a graph node in a method for determining a recommendation indicator of resource information according to an aspect of this disclosure.

FIG. 5 shows an operation of obtaining a first embedding vector representation of a graph node in a method for determining a recommendation indicator of resource information according to an aspect of this disclosure.

FIG. 6 shows a structure of a first graph neural network submodel according to an aspect of this disclosure.

FIG. 7 shows an operation of obtaining a second embedding vector representation of a graph node in a method for determining a recommendation indicator of resource information according to an aspect of this disclosure.

FIG. 8 shows main operations of determining a recommendation indicator of each object for each piece of resource information based on a comprehensive embedding vector representation of each object node and a comprehensive embedding vector representation of each resource information node according to an aspect of this disclosure.

FIG. 9 shows a process of a method for determining a recommendation indicator of resource information according to an aspect of this disclosure.

FIG. 10 shows comparison results between a recommendation system applying a method for determining a recommendation indicator of resource information according to an aspect of this disclosure and a related resource information recommendation system in terms of measurement indicators.

FIG. 11 is a block diagram of an apparatus for determining a recommendation indicator of resource information according to an aspect of this disclosure.

FIG. 12 shows an example system according to an aspect of this disclosure, which includes an example electronic device that represents one or more systems and/or devices that may implement various methods or apparatuses described herein.

### DETAILED DESCRIPTION

The following description provides specific details of various aspects of this disclosure, so that a person skilled in the art can understand and implement the various aspects of this disclosure. The technical solutions of this disclosure may be implemented without some of the details. In some cases, some structures or functions are not shown or described in detail in this disclosure, so as to prevent the unnecessary descriptions from obscuring the description of the aspects of this disclosure. The terms used in this disclosure are to be understood in a broadest reasonable manner thereof, even if the terms are used in combination with specific aspects of this disclosure. Further, the descriptions of the terms are provided as examples only and are not intended to limit the scope of the disclosure.

Artificial intelligence (AI) involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and involves a wide range of fields including both the hardware-level technology and the software-level technology. The basic AI technologies include technologies such as a sensor, a dedicated AI chip, cloud computing, distributed storage, a big data processing technology, an operating/interaction system, and electromechanical integration. AI software technologies mainly include major directions such as a computer vision technology, a speech processing technology, a natural language processing technology, machine learning/deep learning, autonomous driving, intelligent traffic, and automatic control.

Machine learning (ML) is a multi-field interdiscipline, and relates to a plurality of disciplines such as the probability theory, statistics, the approximation theory, convex analysis, and the algorithm complexity theory. ML specializes in studying how a computer simulates or implements a human learning behavior to obtain new knowledge or skills, and reorganize a related knowledge structure, so as to keep improving its performance. ML is the core of AI, is a basic way to make the computer intelligent, and is applied to various fields of AI. ML and deep learning include technologies such as an artificial neural network, a belief network, reinforcement learning, transfer learning, inductive learning, and learning from demonstrations.

Based on this, the aspects of this disclosure provide a method and an apparatus for determining a recommendation indicator of resource information, an electronic device, a computer storage medium, and a computer program product, which can improve recommendation performance of a recommendation system. Descriptions are provided below.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

FIG. 1 shows an implementation environment of a method for determining a recommendation indicator of resource information according to an aspect of this disclosure. As shown in FIG. 1, various types of terminals (for example, a smartphone, a tablet computer, a notebook computer, a desktop computer, an intelligent voice interaction device (for example, a smart speaker), a smart home appliance (for example, a smart television), a smartwatch, an on-board terminal, a wearable device, and a virtual reality (VR) device) communicate with a server through a network. The server may be for example an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a content delivery network, and a big data and artificial intelligence platform. The terminal and the server may be directly or indirectly connected in a wired or wireless communication manner, and the server may also be a node device in a blockchain network.

In an implementation scenario, the terminal may be equipped with a client supporting information recommendation, a user (for example, an operation and maintenance person of a recommendation system) may trigger an information recommendation instruction for resource information on the client of the terminal, and the terminal transmits an information recommendation request to the server in response to the information recommendation instruction. The server is configured to: receive the information recommendation request transmitted by the terminal, and construct a first bipartite graph based on interactive feature data of a plurality of objects for a plurality of pieces of resource information in response to the information recommendation request, the first bipartite graph including a plurality of graph nodes and at least one positive connecting edge, the plurality of graph nodes including an object node of each object and a resource information node of each piece of the resource information, and the positive connecting edge indicating a positive feedback feature of an object of a connected object node of the positive connecting edge for resource information of a connected resource information node of the positive connecting edge; construct a second bipartite graph based on the interactive feature data, the second bipartite graph including a plurality of graph nodes and at least one negative connecting edge, the negative connecting edge indicating a negative feedback feature of an object of a connected object node of the negative connecting edge for resource information of a connected resource information node of the negative connecting edge; determine a comprehensive embedding vector representation of each graph node based on the first bipartite graph and the second bipartite graph; determine a recommendation indicator of each piece of the resource information for each object based on a comprehensive embedding vector representation of each object node and a comprehensive embedding vector representation of each resource information node; and recommend information of each piece of resource information to each object based on the recommendation indicator of each piece of resource information for each object.

The method for determining a recommendation indicator of resource information provided in the aspects of this disclosure may be implemented by various electronic devices. For example, the method may be implemented by a terminal alone, may be implemented by a server alone, or may be implemented by the terminal and the server collaboratively. The method for determining a recommendation indicator of resource information provided in the aspects of this disclosure may be applied to various scenarios, including but not limited to a cloud technology, AI, intelligent traffic, assisted driving, a game, an audio/video, and the like.

All operations in the method for determining a recommendation indicator of resource information described in the aspects of this disclosure may be performed by the server, or may be performed by the terminal. Alternatively, some operations in the method for determining a recommendation indicator of resource information are performed by the server, and some other operations are performed by the terminal. In other words, which operations in the method for determining a recommendation indicator of resource information are performed by the server and which operations are performed by the terminal are not limited in the aspects of this disclosure.

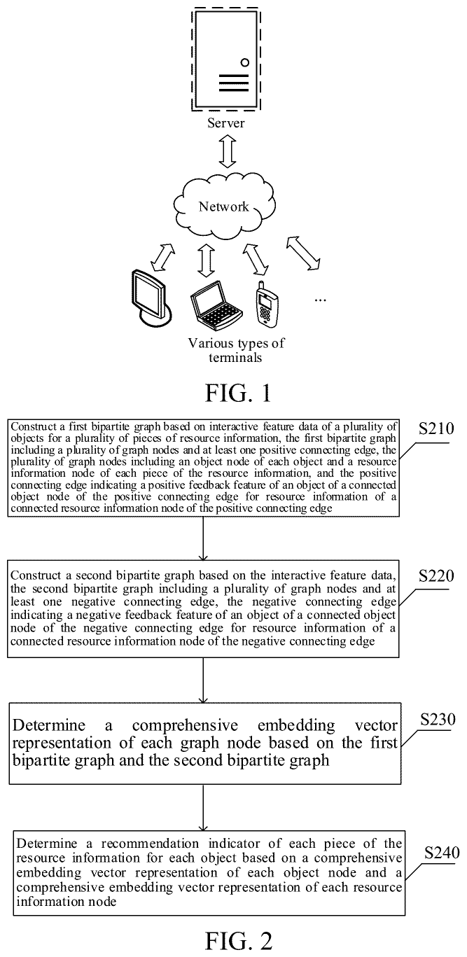

For the sake of simplicity, detailed description is provided below by using an example in which the method for determining a recommendation indicator of resource information is performed by a server. FIG. 2 is a flowchart of a method for determining a recommendation indicator of resource information according to an aspect of this disclosure. As shown in FIG. 2, according to one aspect of this disclosure, the method for determining a recommendation indicator of resource information includes the following operations.

S210: Construct a first bipartite graph based on interactive feature data of a plurality of objects for a plurality of pieces of resource information, the first bipartite graph including a plurality of graph nodes and at least one positive connecting edge, the plurality of graph nodes including an object node of each object and a resource information node of each piece of the resource information, and the positive connecting edge indicating a positive feedback feature of an object of a connected object node of the positive connecting edge for resource information of a connected resource information node of the positive connecting edge. For example, a first bipartite graph is constructed based on interaction feature data that indicate interactions between a plurality of objects and a plurality of pieces of resource information. The first bipartite graph includes (i) a plurality of graph nodes and (ii) a positive connecting edge. The plurality of graph nodes includes an object node for each of the plurality of objects and a resource information node for each of the plurality of pieces of the resource information. The positive connecting edge is between a first object node of the plurality of object nodes and a first resource information node of the plurality of resource information nodes. The positive connecting edge indicates a positive feedback feature between a first object of the plurality of objects that corresponds to the first object node and a first piece of resource information of the plurality of pieces of resource information that corresponds to the first resource information node.

S220: Construct a second bipartite graph based on the interactive feature data, the second bipartite graph including a plurality of graph nodes and at least one negative connecting edge, the negative connecting edge indicating a negative feedback feature of an object of a connected object node of the negative connecting edge for resource information of a connected resource information node of the negative connecting edge. For example, a second bipartite graph is constructed based on the interaction feature data. The second bipartite graph includes the plurality of graph nodes and a negative connecting edge between a second object node of the plurality of object nodes and a second resource information node of the plurality of resource information nodes. The negative connecting edge indicates a negative feedback feature between a second object of the plurality of objects that corresponds to the second object node and a second piece of resource information of the plurality of pieces of resource information that corresponds to the second resource information node.

S230: Determine a comprehensive embedding vector representation of each graph node based on the first bipartite graph and the second bipartite graph. For example, comprehensive embedding vector representations of the plurality of graph nodes are determined based on the first bipartite graph and the second bipartite graph.

S240: Determine a recommendation indicator of each piece of the resource information for each object based on a comprehensive embedding vector representation of each object node and a comprehensive embedding vector representation of each resource information node. For example, the recommendation indicator for each of the plurality of pieces of resource information with respect to each of the plurality of objects is determined based on the comprehensive embedding vector representation of the object node corresponding to the respective object and the comprehensive embedding vector representation of the resource information node corresponding to the respective piece of resource information.

The “object” mentioned herein may be a user of a terminal device, and the “resource information” may be a to-be-recommended object that has an association relationship with the user. For example, the “resource information” includes, but is not limited to, a to-be-recommended object that has been recommended to the user, a to-be-recommended object that has been clicked/tapped by the user, or a to-be-recommended object that the user clicks/taps and is intended to obtain. The resource information includes, but is not limited to, information such as a commodity, an article, a video, and an audio. The interactive feature data herein refers to data of interactive behaviors (for example, historical interactive behaviors) of a plurality of objects for a plurality of pieces of resource information. The interactive behaviors include, but are not limited to, clicking/tapping, giving a review, giving a like, sharing, obtaining or downloading based on resource information, and the like. Based on this, in S210 and S220, the first bipartite graph and the second bipartite graph are constructed based on the interactive feature data of the plurality of objects for the plurality of pieces of resource information. Herein, the first bipartite graph includes a plurality of graph nodes and at least one positive connecting edge, and the second bipartite graph also includes the plurality of graph nodes. The second bipartite graph further includes at least one positive connecting edge. The plurality of graph nodes include the object node of each object and the resource information node of each piece of resource information. The positive connecting edge indicates a positive feedback feature of the object of the connected object node of the positive connecting edge for the resource information of the connected resource information node of the positive connecting edge. The negative connecting edge indicates a negative feedback feature of the object of the connected object node of the negative connecting edge for the resource information of the connected resource information node of the negative connecting edge.

The “positive feedback feature” mentioned herein refers to a positive feedback feature generated by an object toward resource information. For example, the object receives a certain piece of resource information, and then clicks/taps a link related to the resource information, or performs an operation of downloading or obtaining, or gives feedback information such as a favorable review, a like, or a high score. This type of data is the positive feedback feature. The “negative feedback feature” mentioned herein refers to a negative feedback feature of the object toward the resource information. For example, after the resource information is exposed to the object, the object does not click/tap a link related to the resource information, or skips the resource information, or even gives feedback information such as a bad review or a low score. This type of data is the negative feedback feature.

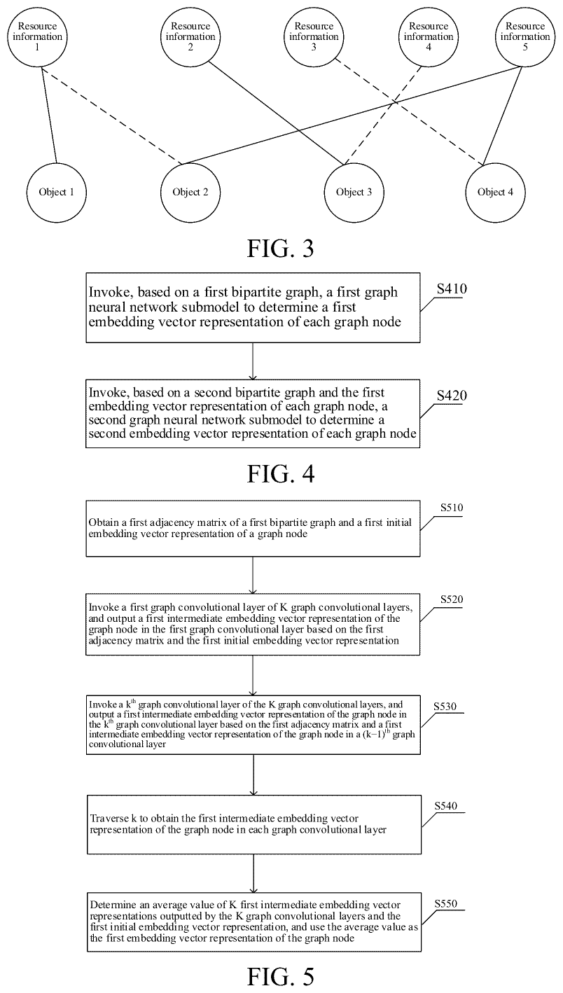

The “bipartite graph” mentioned herein is a special graph structure. A vertex set in the graph structure may be divided into two subsets that do not intersect each other, and two vertices to which each edge in the graph structure is attached belong to the two subsets that do not intersect each other. The vertices in the two subsets are not adjacent. FIG. 3 schematically shows an example of a bipartite graph. A vertex set of the bipartite graph includes an object node of an object and a resource information node of resource information. FIG. 3 shows four object nodes (which respectively correspond to an object 1, an object 2, an object 3, and an object 4) and five resource information nodes (which respectively correspond to resource information 1, resource information 2, resource information 3, resource information 4, and resource information 5). In FIG. 3, an edge between nodes indicated by a solid line is configured to represent a positive feedback feature between the object and corresponding resource information, and the edge indicating the positive feedback feature is also referred to as a positive connecting edge. In FIG. 3, an edge between nodes indicated by a dashed line is configured to represent a negative feedback feature between the object and the corresponding resource information, and the edge indicating the negative feedback feature is also referred to as a negative connecting edge.

The bipartite graph mentioned herein may be represented by a corresponding adjacency matrix. The adjacency matrix is a matrix of N*N, N being a quantity of graph nodes in the bipartite graph. The adjacency matrix is difficult to be used as a feature space of a large graph. Therefore, graph node attribute need to be transformed into a vector with a smaller dimension. The vector is also referred to as an embedding vector representation. In the foregoing aspects of this disclosure, the first bipartite graph and the second bipartite graph include the same node information. In other words, the first bipartite graph and the second bipartite graph include the same object node and resource information node. A difference between the first bipartite graph and the second bipartite graph is that an edge between a node of the first bipartite graph and a node of the second bipartite graph represents a different relationship. An edge between an object node and a resource information node in the first bipartite graph is defined as a positive connecting edge, which is configured to indicate the positive feedback feature of the object of the connected object node of the positive connecting edge for the resource information of the connected resource information node of the positive connecting edge. An edge between an object node and a resource information node in the second bipartite graph is defined as a negative connecting edge, which is configured to indicate the negative feedback feature of the object of the connected object node of the negative connecting edge for the resource information of the connected resource information node of the negative connecting edge.

After the first bipartite graph and the second bipartite graph are constructed based on the interactive feature data, in S230, the comprehensive embedding vector representation of each graph node is determined based on the first bipartite graph and the second bipartite graph, namely, the comprehensive embedding vector representation of each object node and the comprehensive embedding vector representation of each resource information node. Then in S240, a recommendation indicator of each piece of the resource information for each object is determined based on the comprehensive embedding vector representation of each object node and the comprehensive embedding vector representation of each resource information node. The “recommendation indicator” herein refers to an indicator and a corresponding indicator value. A recommendation indicator of a piece of resource information for an object is configured for measuring a recommendation possibility (or a recommendation probability) of recommending the resource information to the object. For example, the indicator value of the recommendation indicator may be characterized by a recommendation score value of recommending the resource information to the object (the recommendation score value is positively correlated with the recommendation possibility). In this way, the resource information may be recommended to the object through the recommendation score value of each piece of resource information for the object (for example, the resource information whose recommendation score value is higher than a score threshold is recommended to the object, or a certain amount of resource information with the recommendation score value ranking high in descending order is recommended to the object). In an example, the recommendation indicator includes, but is not limited to a degree of interest of the object for the resource information (which may be characterized by a recommendation score value) and an interaction probability of the object for the resource information (which may be characterized by the recommendation score value such as a clicking/tapping probability, a review probability, a sharing probability, a high scoring probability with a score higher than a score threshold, or a liking probability).

Through application of the foregoing aspects, the negative feedback information of the object for the resource information is not ignored or discarded, but the first bipartite graph and the second bipartite graph are respectively constructed by using the positive feedback information and the negative feedback information, then the comprehensive embedding vector representation of each graph node in the bipartite graph is determined by using a graph neural network model, and then prediction of the recommendation indicator of each resource information for each object is implemented based on the comprehensive embedding vector representation of each object node and the comprehensive embedding vector representation of each resource information node, so as to recommend the resource information to the object based on the recommendation indicator. In other words, in the aspects of this disclosure, the positive feedback information and the negative feedback information of the objects for the resource information are comprehensively considered, so that the recommendation indicator of the resource information for the object can be more accurately determined, thereby improving accuracy of recommendation based on the recommendation indicator, and then improving the recommendation performance of the recommendation system and user experience of receiving recommended resource information.

In some aspects, S230 described above may be implemented through the following operations. S2301: Determine a first embedding vector representation and a second embedding vector representation of each graph node based on the first bipartite graph and the second bipartite graph. S2302: Splice, for each graph node, the first embedding vector representation and the second embedding vector representation of the graph node, to obtain a comprehensive embedding vector representation of the graph node.

Herein, the splicing process in S2302 may be addition splicing, multiplication splicing, or the like. S2301 may be implemented by a pre-trained graph neural network model. To be specific, the graph neural network model is invoked based on the first bipartite graph and the second bipartite graph, to determine the first embedding vector representation and the second embedding vector representation of each graph node. In some aspects, the graph neural network model includes a first graph neural network submodel and a second graph neural network submodel. Based on this, as shown in FIG. 4, that the graph neural network model is invoked based on the first bipartite graph and the second bipartite graph, to determine the first embedding vector representation and the second embedding vector representation of each graph node includes the following operations. S410: Invoke, based on the first bipartite graph, the first graph neural network submodel to determine the first embedding vector representation of each graph node. For example, the first graph neural network submodel is invoked based on the first bipartite graph to determine the first embedding vector representation of the respective graph node. S420: Invoke, based on the second bipartite graph and the first embedding vector representation of each graph node, the second graph neural network submodel to determine the second embedding vector representation of each graph node. For example, the second graph neural network submodel is invoked based on the second bipartite graph and the first embedding vector representation of the respective graph node to determine the second embedding vector representation of the respective graph node.

The first graph neural network submodel and the second graph neural network submodel may include any appropriate graph convolutional neural network. In some aspects, the first graph neural network submodel may be based on light graph convolution (LGC). For example, the first graph neural network submodel may include K (K is an integer greater than 1) graph convolutional layers. Each graph convolutional layer is configured to generate a first intermediate embedding vector representation. Based on this, as shown in FIG. 5, the first embedding vector representation of each graph node in the foregoing operation S410 may be determined through the following operations. S510: Obtain a first adjacency matrix of the first bipartite graph and a first initial embedding vector representation of the graph node. For example, a first adjacency matrix of the first bipartite graph and a first initial embedding vector representation for each graph node are obtained. S520: Invoke a first graph convolutional layer of K graph convolutional layers, and output a first intermediate embedding vector representation of the graph node in the first graph convolutional layer based on the first adjacency matrix and the first initial embedding vector representation. For example, when k is equal to 1, a first intermediate embedding vector representation of the respective graph node is generated via graph convolution based on the first adjacency matrix and the first initial embedding vector representation. S530: Invoke a k^{th} graph convolutional layer of the K graph convolutional layers, and output a first intermediate embedding vector representation of the graph node in the k^{th} graph convolutional layer based on the first adjacency matrix and a first intermediate embedding vector representation of the graph node in a (k−1)^{th} graph convolutional layer. S540: Traverse k to obtain the first intermediate embedding vector representation of the graph node in each graph convolutional layer, the k being an integer greater than 1, and the k being less than or equal to K. For example, when k is greater than 1, the first intermediate embedding vector representation of the respective graph node is generated via the graph convolution based on the first adjacency matrix and the first intermediate embedding vector representation output by a (k−1)^{th} graph convolutional layer. S550: Determine an average value of K first intermediate embedding vector representations outputted by the K graph convolutional layers and the first initial embedding vector representation, and use the average value as the first embedding vector representation of the graph node. For example, the first embedding vector representation of the respective graph node is determined based on an average value of K first intermediate embedding vector representations and the first initial embedding vector representation.

Herein, the first initial embedding vector representation in S510 may be preset. In S520, an input to the first graph convolutional layer is the first adjacency matrix and the first initial embedding vector representation, and an output thereof is the first intermediate embedding vector representation of the first graph convolutional layer. In S530, an input to the k^{th} graph convolutional layer is an output of the (k−1)^{th} graph convolutional layer and the first adjacency matrix, and an output thereof is the first intermediate embedding vector representation of the k^{th} graph convolutional layer. In S540, the first intermediate embedding vector representation outputted by each graph convolutional layer of the K graph convolutional layers can be obtained through traversal of the k, i.e., K first intermediate embedding vector representations. In S550, the average value of the K first intermediate embedding vector representations outputted by the K graph convolutional layers and the first initial embedding vector representation is calculated to obtain the first embedding vector representation of the graph node. In this way, a feature expression capability of the obtained first embedding vector representation can be improved through feature extraction of multi-layer graph convolutional layers, thereby improving accuracy of a recommendation indicator determined based on the first embedding vector representation.

As described above, the first bipartite graph includes a positive connecting edge indicating a positive feedback feature of an object corresponding to an object node for resource information corresponding to a resource information node. Therefore, the first adjacency matrix of the first bipartite graph may also be referred to as a positive adjacency matrix. The positive adjacency matrix A⁺ may be expressed as

$${A}^{+} = ( \begin{matrix}0 & {R}^{+} \\ {R}^{+ T} & 0\end{matrix} ) ,$$

where R⁺ is an object-resource information interaction matrix including the positive feedback feature of the object for the resource information, R⁺ is an M*N matrix, Mis a quantity of object nodes, and Nis a quantity of resource information nodes. If an object interacts with a certain piece of resource information, a corresponding element in the matrix R⁺ is 1, otherwise the element is 0. Similarly, the adjacency matrix of the second bipartite graph may be referred to as a negative adjacency matrix. The negative adjacency matrix A⁻ may be expressed as

$${A}^{-} = ( \begin{matrix}0 & {R}^{-} \\ {R}^{- T} & 0\end{matrix} ) ,$$

where R⁻ is an object-resource information interaction matrix including a negative feedback feature of the object for the resource information, R⁻ is an M*N matrix, M is the quantity of object nodes, and Nis the quantity of resource information nodes.

In some aspects, a convolution operation of each graph convolutional layer in the foregoing first graph neural network submodel may be expressed as the following formula:

$${Z}^{+ ( l + 1 )} = {D}^{{+}^{- 1 / 2}} {A}^{+} {D}^{{+}^{- 1 / 2}} {Z}^{+ ( l )}$$

where D⁺ is a diagonal matrix of (M+N)×(M+N), and each element Dᵢᵢ in the diagonal matrix D⁺ represents a quantity of non-zero elements in an i^{th} row vector of the positive adjacency matrix A⁺. In a case that the first initial embedding vector representation Z⁺^{⁽⁰⁾} of a certain graph node is given, the first graph convolutional layer may output a corresponding first intermediate embedding vector representation Z⁺^{⁽¹⁾} based on the first initial embedding vector representation Z⁺^{⁽⁰⁾} and the positive adjacency matrix A⁺. Similarly, a next graph convolutional layer in the K graph convolutional layers outputs a corresponding first intermediate embedding vector representation Z⁺^{^{(l+1)}} based on a first intermediate embedding vector representation Z⁺^{^{(l)}} outputted by a previous graph convolutional layer and the positive adjacency matrix A⁺ of the first bipartite graph. In this way, a total of K first intermediate embedding vector representations of the graph node are obtained, so that the average value of the K first intermediate embedding vector representations outputted by the K graph convolutional layers and the first initial embedding vector representation Z⁺^{⁽⁰⁾} can be determined, and the average value is used as the first embedding vector representation Z⁺ of the graph node, i.e.,

$${Z}^{+} = \frac{1}{k + 1} {\sum }_{i = 0}^{k} {Z}^{+ ( i )} .$$

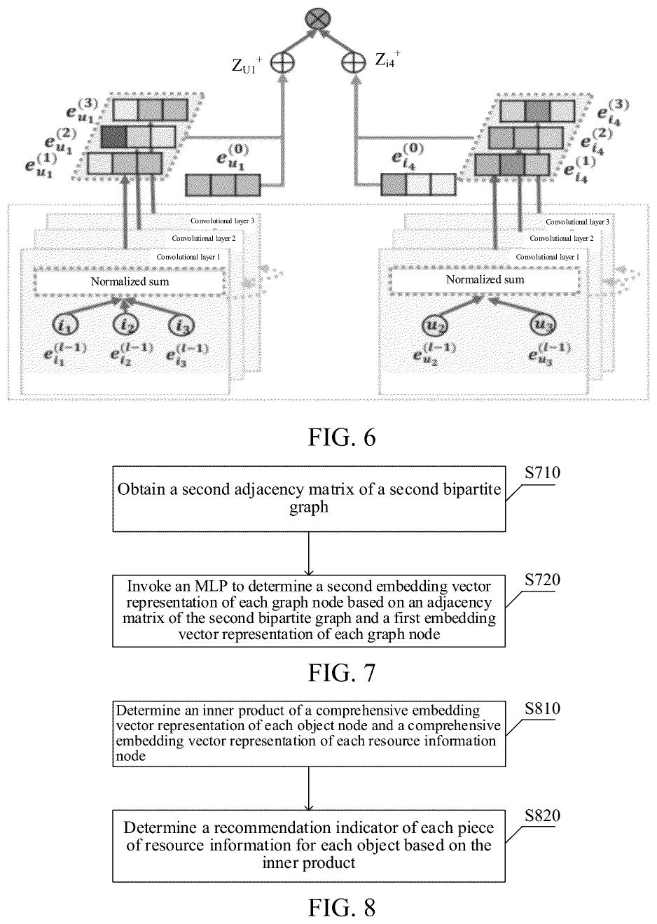

In an example, FIG. 6 shows a structure of a first graph neural network submodel. In some aspects, a graph convolution operation of a graph convolutional layer may further be expressed as the following formula:

$${e}_{u}^{( k + 1 )} = {\sum }_{i ∈ {N}_{u}} \frac{1}{\sqrt{\vert {N}_{u} \vert} \sqrt{\vert {N}_{i} \vert}} {e}_{i}^{( k )} ; and$$

$${e}_{i}^{( k + 1 )} = {\sum }_{i = u ∈ {N}_{i}} \frac{1}{\sqrt{\vert {N}_{u} \vert} \sqrt{\vert {N}_{i} \vert}} {e}_{u}^{( k )}$$

where in eᵤ^{(k)} and eᵢ^{(k), e}ᵤ^{(k)} represents a first intermediate embedding vector representation obtained by an object node u through propagation of k graph convolutional layers, and eᵢ^{(k)} represents a first intermediate embedding vector representation obtained by a resource information node i through propagation of the k graph convolutional layers. Nᵤ represents a set of resource information interacting with an object corresponding to the object node u, and Ni represents a set of objects interacting with resource information corresponding to the resource information node i. The formula of the graph convolution operation of the graph convolutional layer in FIG. 6 (i.e., the formula in which each graph convolutional layer outputs the first intermediate embedding vector representation) is also referred to as a normalized sum. In FIG. 6, eᵤ₁⁽⁰⁾ represents a first initial embedding vector representation of an object node u1, and eᵢ₄⁽⁰⁾ represents a first initial embedding vector representation of a resource information node i4. In a case that the first initial embedding vector representation for each graph node (including the object node and the resource information node described above) is given, the first intermediate embedding vector representation of each graph convolutional layer may be obtained based on the foregoing formula. Finally, an average value of each first intermediate embedding vector representation outputted by each graph convolutional layer and the first initial embedding vector representation of the graph node is calculated, and the average value is used as the first embedding vector representation of the graph node. The processing process of the first graph neural network submodel shown in FIG. 6 is to process the object node and the resource information node separately. For example, a left part of FIG. 6 schematically shows a process of obtaining the first embedding vector representation Zᵤ₁⁺ of the object node u1, and a right part of FIG. 6 schematically shows a process of obtaining the first embedding vector representation Zᵢ₄⁺ of the resource information node i4.

In some aspects, a second graph neural network submodel includes a multilayer perceptron (MLP). As shown in FIG. 7, S420 described above may be implemented through the following operations. S710: Obtain a second adjacency matrix of a second bipartite graph. For example, a second adjacency matrix of the second bipartite graph is obtained. S720: Invoke the MLP to determine a second embedding vector representation of each graph node based on the second adjacency matrix and the first embedding vector representation of each graph node. For example, the MLP is invoked based on the second adjacency matrix and the first embedding vector representation of the respective graph node to determine the second embedding vector representation of the respective graph node.

Herein, in S710, the second bipartite graph includes a negative connecting edge indicating a negative feedback feature of an object corresponding to an object node for resource information corresponding to a resource information node. Therefore, an adjacency matrix of the second bipartite graph may be referred to as a negative adjacency matrix. The negative adjacency matrix A⁻ may be expressed as

$${A}^{-} = ( \begin{matrix}0 & {R}^{-} \\ {R}^{- T} & 0\end{matrix} ) ,$$

where R⁻ is an object-resource information interaction matrix including the negative feedback feature of the object for the resource information, R⁻ is an M*N matrix, M is a quantity of object nodes, and N is a quantity of resource information nodes. In S720, the second embedding vector representation Z⁻ of each graph node may be obtained through the following formula:

$${Z}^{-} = M L P ( {D}^{{-}^{- 1 / 2}} {A}^{-} {D}^{{-}^{- 1 / 2}} {Z}^{+} )$$

where D⁻ is a diagonal matrix of (M+N)×(M+N), and each element Dᵢᵢ in the diagonal matrix D⁻ represents a quantity of non-zero elements in an i^{th} row vector of the negative adjacency matrix A⁻.

In this way, a comprehensive embedding vector representation of each graph node may be obtained based on the first embedding vector representation and the second embedding vector representation of each graph node that are obtained. In other words, the first embedding vector representation Z⁺ and the second embedding vector representation Z⁻ of each graph node are spliced to obtain the comprehensive embedding vector representation Z of the graph node, i.e., Z=Z+|Z⁻. Therefore, a recommendation indicator may be predicted based on the comprehensive embedding vector representation of each graph node. Herein, the embedding vector representations (including the first embedding vector representation and the second embedding vector representation) of the graph node are obtained in different manners, and the comprehensive embedding vector representation of the graph node is obtained by splicing the embedding vector representations obtained in the two manners, which can improve a feature expression effect of the graph node, thereby improving accuracy of the recommendation indicator determined based on the comprehensive embedding vector representation, and thus improving recommendation performance of a recommendation system.

As shown in FIG. 8, in some aspects, operation 240 described above may be implemented through the following operations. S810: Determine an inner product of the comprehensive embedding vector representation of each object node and the comprehensive embedding vector representation of each resource information node. For example, an inner product of the comprehensive embedding vector representation of each of the plurality of object nodes and the comprehensive embedding vector representation of each of the plurality of resource information nodes is determined. S820: Determine the recommendation indicator of each piece of the resource information for each object based on the inner product. For example, the recommendation indicator for each of the plurality of pieces of resource information with respect to each of the plurality of objects is determined based on the inner product of the comprehensive embedding vector representation of the respective object node and the comprehensive embedding vector representation of the respective resource information node. For a certain object, a value of the inner product of the comprehensive embedding vector representation of the object node of the object and the comprehensive embedding vector representation of each resource information node may be used as a recommendation score value for recommending resource information to the object. The recommendation score value characterizes an indicator value of the recommendation indicator.

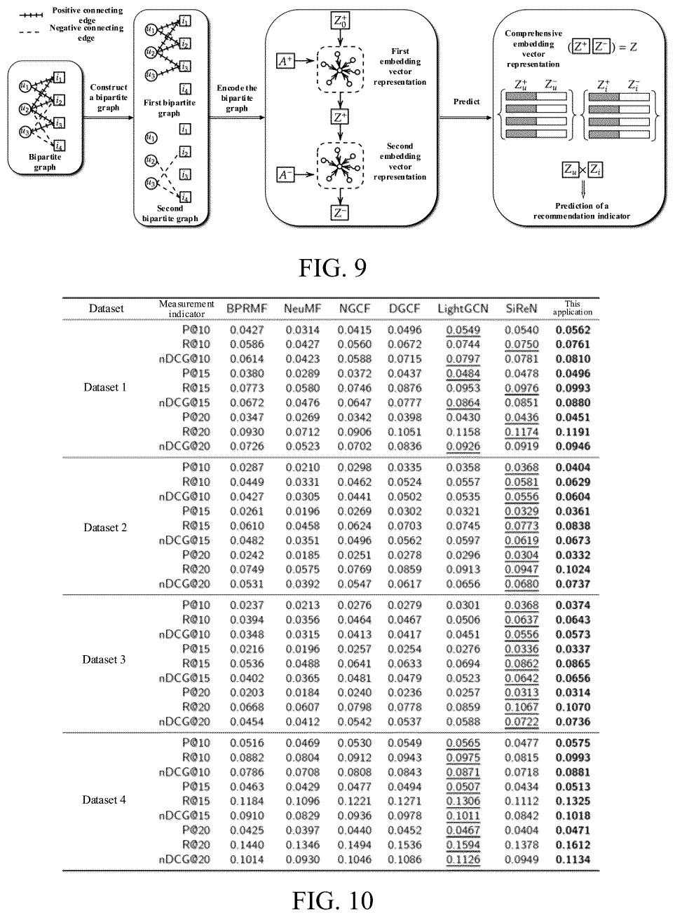

FIG. 9 schematically shows a process of a method for determining a recommendation indicator of resource information according to an aspect of this disclosure. As shown in FIG. 9, a bipartite graph may be constructed based on interactive feature data of a plurality of objects for a plurality of pieces of resource information. The bipartite graph shown in FIG. 9 includes three object nodes u1, u2, and u3, and four resource information nodes i1, i2, i3, and i4. The bipartite graph includes a positive connecting edge and a negative connecting edge. Based on the positive connecting edge and the negative connecting edge, the constructed bipartite graph may be divided into a first bipartite graph and a second bipartite graph. The first bipartite graph includes at least one positive connecting edge. Each positive connecting edge indicates a positive feedback feature of an object corresponding to an object node (the connected object node of the positive connecting edge) for resource information corresponding to a resource information node (the connected resource information node of the positive connecting edge). The second bipartite graph includes at least one negative connecting edge. Each negative connecting edge indicates a negative feedback feature of an object corresponding to an object node (the connected object node of the negative connecting edge) for resource information corresponding to a resource information node (the connected resource information node of the negative connecting edge).

Still referring to FIG. 9, the bipartite graph may be encoded to obtain a first embedding vector representation Z⁺ and a second embedding vector representation Z^{″} of each graph node in the bipartite graph. Specifically, the first embedding vector representation Z⁺ of the graph node may be obtained based on a positive adjacency matrix A⁺ of the first bipartite graph and a first initial embedding vector representation Z₀⁺ of the graph node by using a first graph neural network submodel. The second embedding vector representation Z⁻ of the graph node may be obtained based on a negative adjacency matrix A⁻ of the second bipartite graph and the first embedding vector representation Z⁺ of the graph node by using a second graph neural network submodel. Based on this, a comprehensive embedding vector representation Z=Z⁺||Z⁻ of the graph node is obtained. To be specific, a comprehensive embedding vector representation Zu of each object node includes a first embedding vector representation Zᵤ⁺ and a second embedding vector representation Zᵤ⁻, and a comprehensive embedding vector representation Zᵢ of each resource information node includes a first embedding vector representation Zᵢ⁺ and a second embedding vector representation Zᵢ⁻. Finally, an inner product Zu×Zi of the comprehensive embedding vector representation of each object node and the comprehensive embedding vector representation of each resource information node is determined, and a recommendation indicator of each piece of resource information for each object is determined based on the inner product.

In some aspects, the foregoing graph neural network model is obtained by training an initial graph neural network model. A training process of the initial graph neural network model includes: training the initial graph neural network model by using the positive connecting edge of the first bipartite graph and the negative connecting edge of the second bipartite graph, until a loss function of the initial graph neural network model reaches a minimum value, thereby obtaining an expected graph neural network model. In the foregoing aspects, the graph neural network model includes the first graph neural network submodel and the second graph neural network submodel. The first graph neural network submodel and the second graph neural network submodel may be used as a whole and trained simultaneously.

In some aspects, a loss function of the graph neural network model includes at least one of a Bayesian personalized ranking (BPR) loss function and a cosine loss function. In an example, a loss function L of the graph neural network model may include a BPR loss function L_{bpr} and a cosine loss function L_{cos}. The loss function L for the graph neural network model may be expressed as the following formula:

$$L = {L}_{b p r} + {λ}_{1} {L}_{c o s}$$

where λ₁ is a hyper-parameter, which is configured for adjusting impact of different loss functions. Herein, the BPR loss function L_{bpr} is L_{bpr}=−log(y_{u,i}−y_{u,j}), where y_{u,i}=zᵤ^{T}zᵢ, zᵤ is a comprehensive embedding vector representation of an object node u, and zᵢ is a comprehensive embedding vector representation of a resource information node i of resource information interacting with an object corresponding to the object node u. y_{u,j}=zᵤ^{T}zⱼ, where zⱼ is a comprehensive embedding vector representation of a resource information node of resource information without interaction with the object corresponding to the object node u.

Herein, the cosine loss function L_{cos} may be configured for predicting a positive feedback or a negative feedback of the object to the resource information. For the object node u and the resource information node i, the comprehensive embedding vector representation zᵤ corresponding to the object node and the comprehensive embedding vector representation zᵢ corresponding to the resource information node may be obtained, so that a cosine of an included angle between zᵤ and zᵢ may be calculated. The cosine loss function L_{cos} may be expressed as:

$${L}_{cos} = \{ \begin{matrix}1 - cos ( {z}_{u} , {z}_{i} ) , & y = 1 \\ w * max ( 0 , cos ( {z}_{u} , {z}_{i} ) - μ ) , & y = - 1\end{matrix}$$

where w and μ are hyper-parameters configured for controlling a difference between the cosine of the included angle and an actual result y, and a numerical value of μ may be greater than 0 and less than 1.

In some other aspects, the loss function L for the graph neural network model further includes a regular term L_{reg}. To be specific, the loss function L may be expressed as:

$$L = {L}_{bpr} + {λ}_{1} {L}_{c o s} + {λ}_{2} {L}_{r e g}$$

where λ₁ and λ₂ are hyper-parameters, which are configured for adjusting impact of different loss functions. The regular term L_{reg} includes an L2 norm of a parameter of the graph neural network model, L_{reg}=∥Φ∥₂, and Φ is the parameter of the graph neural network model, including all parameters of the first graph neural network submodel and the second graph neural network submodel.

In an example, the method for determining a recommendation indicator of resource information provided in the aspects of this disclosure may be applied to a resource information recommendation system. To verify the effect of the method for determining a recommendation indicator of resource information provided in the aspects of this disclosure, the graph neural network model adopted in the aspects of this disclosure and other models adopted in the related resource information recommendation system are tested on four different datasets (including a dataset 1 to a dataset 4). The examples of the models adopted in the related resource information recommendation system include a BPR matrix factorization (BPRMF) network, a neural matrix factorization (NeuMF) network, a neural graph collaborative filtering (NGCF) network, a disentangled graph collaborative filtering (DGCF) network, a light graph convolution network (LightGCN), and a sinusoidal representation network (SiReN). Measurement indicators include an accuracy rate of top ten pieces of recommended resource information P@10, a recall rate of the top ten pieces of recommended resource information R@ 10, a normalized discounted cumulative gain of the top ten pieces of recommended resource information nDCG@10, an accuracy rate of top fifteen pieces of recommended resource information P@ 15, a recall rate of the top fifteen pieces of recommended resource information R@ 15, a normalized discounted cumulative gain of the top fifteen pieces of recommended resource information nDCG@15, an accuracy rate of top twenty pieces of recommended resource information P@20, a recall rate of the top twenty pieces of recommended resource information R@20, and a normalized discounted cumulative gain of the top twenty pieces of recommended resource information nDCG@20.

FIG. 10 shows comparison results between a resource information recommendation system based on the method for determining a recommendation indicator of resource information according to an aspect of this disclosure and an related resource information recommendation system during resource information recommendation in terms of the foregoing measurement indicators. It may be seen from FIG. 10 that the resource information recommendation system based on the method for determining a recommendation indicator of resource information according to the aspect of this disclosure has significant advantages in various measurement indicators. Therefore, recommendation of resource information performed by using the method for determining a recommendation indicator of resource information according to the aspect of this disclosure may improve accuracy of resource information recommendation and enhance user experience of receiving recommended resource information.

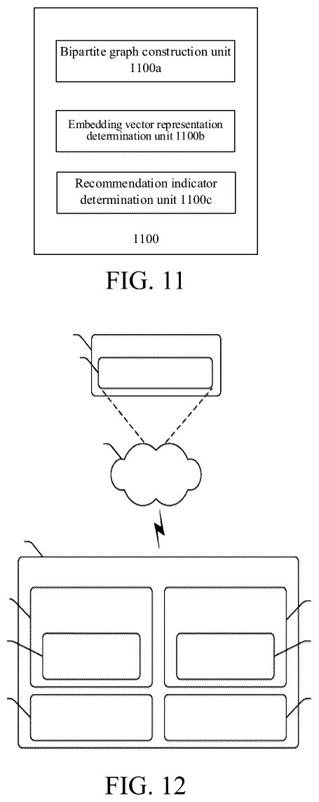

An aspect of this disclosure further provides an apparatus for determining a recommendation indicator of resource information. As shown in FIG. 11, the apparatus includes: a bipartite graph construction unit 1100a, configured to: construct a first bipartite graph based on interactive feature data of a plurality of objects for a plurality of pieces of resource information, the first bipartite graph including a plurality of graph nodes and at least one positive connecting edge, the plurality of graph nodes including an object node of each of the objects and a resource information node of each piece of the resource information, and the positive connecting edge indicating a positive feedback feature of an object of a connected object node of the positive connecting edge for resource information of a connected resource information node of the positive connecting edge; and construct a second bipartite graph based on the interactive feature data, the second bipartite graph including a plurality of graph nodes and at least one negative connecting edge, the negative connecting edge indicating a negative feedback feature of an object of a connected object node of the negative connecting edge for resource information of a connected resource information node of the negative connecting edge; an embedding vector representation determination unit 1100b, configured to determine a comprehensive embedding vector representation of each of the graph nodes based on the first bipartite graph and the second bipartite graph; and a recommendation indicator determination unit 1100c, configured to determine a recommendation indicator of each piece of the resource information for each object based on a comprehensive embedding vector representation of each object node and a comprehensive embedding vector representation of each resource information node.

In some aspects, the embedding vector representation determination unit 1100b is further configured to determine a first embedding vector representation and a second embedding vector representation of each graph node based on the first bipartite graph and the second bipartite graph; and splice, for each graph node, the first embedding vector representation and the second embedding vector representation of the graph node, to obtain a comprehensive embedding vector representation of the graph node.

In some aspects, the embedding vector representation determination unit 1100b is further configured to invoke, based on the first bipartite graph and the second bipartite graph, a graph neural network model to determine the first embedding vector representation and the second embedding vector representation of each graph node.

In some aspects, the graph neural network model includes a first graph neural network submodel and a second graph neural network submodel. The embedding vector representation determination unit 1100b is further configured to invoke, based on the first bipartite graph, the first graph neural network submodel to determine the first embedding vector representation of each graph node; and invoke, based on the second bipartite graph and the first embedding vector representation of each graph node, the second graph neural network submodel to determine the second embedding vector representation of each graph node.

In some aspects, the first graph neural network submodel includes K graph convolutional layers. The embedding vector representation determination unit 1100b is further configured to perform the following processing for each graph node: obtaining a first adjacency matrix of the first bipartite graph and a first initial embedding vector representation of the graph node; invoking a first graph convolutional layer of the K graph convolutional layers, and outputting a first intermediate embedding vector representation of the graph node in the first graph convolutional layer based on the first adjacency matrix and the first initial embedding vector representation; invoking a k^{th} graph convolutional layer of the K graph convolutional layers, and outputting a first intermediate embedding vector representation of the graph node in the k^{th} graph convolutional layer based on the first adjacency matrix and a first intermediate embedding vector representation of the graph node in a (k−1)^{th} graph convolutional layer; traversing k to obtain the first intermediate embedding vector representation of the graph node in each of the graph convolutional layers, K and the k being both integers greater than 1, and the k being less than or equal to the K; and determining an average value of K first intermediate embedding vector representations outputted by the K graph convolutional layers and the first initial embedding vector representation, and using the average value as the first embedding vector representation of the graph node.

In some aspects, the second graph neural network submodel includes an MLP. The embedding vector representation determination unit 1100b is further configured to obtain a second adjacency matrix of the second bipartite graph; and invoke the MLP to determine the second embedding vector representation of each graph node based on the second adjacency matrix and the first embedding vector representation of each graph node.

In some aspects, the embedding vector representation determination unit 1100b is further configured to train the initial graph neural network model by using the positive connecting edge of the first bipartite graph and the negative connecting edge of the second bipartite graph, until a loss function of the initial graph neural network model reaches a minimum value.

In some aspects, the recommendation indicator determination unit 1100c is further configured to determine an inner product of the comprehensive embedding vector representation of each object node and the comprehensive embedding vector representation of each resource information node; and determine the recommendation indicator of each piece of the resource information for each object based on the inner product.

An aspect of this disclosure further provides an electronic device. The electronic device includes: a memory (e.g., a non-transitory computer-readable storage medium), configured to store a computer-executable instruction; and a processor (e.g., processing circuitry), configured to perform the operations in the method according to any one of the foregoing aspects when the computer-executable instruction is executed by the processor.

Particularly, the method described above with reference to the flowcharts may be implemented as a computer program. For example, an aspect of this disclosure provides a computer program product, the computer program product including a computer program carried on a computer-readable medium, the computer program including program code for performing at least one operation of the method for determining a recommendation indicator of resource information in the foregoing aspects.

An aspect of this disclosure further provides one or more computer-readable storage media, having a computer-readable instruction stored therein, the computer-readable instruction, when executed, implementing the method for determining a recommendation indicator of resource information provided in the aspects of this disclosure. Each operation of the method for determining a recommendation indicator of resource information may be converted into a computer-readable instruction through programming, and then stored in a computer-readable storage medium such as a non-transitory computer-readable storage medium. When such a computer-readable storage medium is read or accessed by an electronic device or a computer, the computer-readable instruction therein is executed by a processor on the electronic device or the computer to implement the method for determining a recommendation indicator of resource information.

FIG. 12 shows an example system, which includes an example electronic device 1210 representing one or more systems and/or devices that may implement the technical solutions described in the aspects herein. The electronic device 1210 may be, for example, a server of a service provider, a device associated with the server, a system on chip, and/or any other suitable electronic device or computing system. The apparatus 1100 for determining a recommendation indicator of resource information described above with reference to FIG. 11 may be in a form of the electronic device 1210. Alternatively, the apparatus 1100 for determining a recommendation indicator of resource information may be implemented as a computer program in the form of an application 1216.

The example electronic device 1210 shown in FIG. 12 includes a processing system 1211, one or more computer-readable media 1212, and one or more input/output (I/O) interfaces 1213 communicatively coupled to each other. Although not shown, the electronic device 1210 may further include a system bus or another data and command transmission system that couples various assemblies to each other. The system bus may include any one or combination of different bus structures. The bus structures include a memory bus or a memory controller, a peripheral bus, a universal serial bus, and/or a processor or a local bus using any of various bus architectures.

The processing system 1211 is configured to perform one or more operations by using hardware. Therefore, the processing system 1211 is shown as including a hardware element 1214 that may be configured as a processor, a functional block, or the like. The hardware element may include implementation in hardware as an application specific integrated circuit (ASIC) or another logic device formed by one or more semiconductors. The hardware element 1214 is not limited by a material from which the hardware element is formed or a processing mechanism adopted therein. For example, a processor may include (a plurality of) semiconductors and/or transistors (for example, an electronic integrated circuit (IC)). In such a context, a processor-executable instruction may be an electronically executable instruction.

The computer-readable medium 1212 is shown as including a memory/storage apparatus 1215. The memory/storage apparatus 1215 represents a memory/storage capacity associated with one or more computer-readable media. The memory/storage apparatus 1215 may include a volatile medium (such as a random access memory (RAM)) and/or a non-volatile medium (such as a read-only memory (ROM), a flash memory, an optical disc, or a magnetic disk). The memory/storage apparatus 1215 may include a fixed medium (such as a RAM, a ROM, and a fixed hard disk drive) and a removable medium (such as a flash memory, a removable hard disk drive, or an optical disc). The computer-readable medium 1212 may be configured in various other manners further described below. One or more I/O interfaces 1213 are configured to allow a user to input a command and information to the electronic device 1210 by using various input devices, and in some aspects, further allow presenting the information to the user and/or another assembly or device by using various output devices. An example of the input device includes a keyboard, a cursor control device (for example, a mouse), a microphone (for example, configured for voice input), a scanner, a touch function (for example, a capacitive sensor or another sensor configured to detect physical touch), a camera (for example, a motion that does not involve touch may be detected as a gesture by using a visible or invisible wavelength (such as an infrared frequency)), or the like. An example of output device includes a display device (for example, a display or a projector), a speaker, a printer, a network card, a tactile response device, or the like. Therefore, the electronic device 1210 may be configured in various manners as further described below to support user interaction.

The electronic device 1210 further includes an application 1216. The application 1216 may be, for example, a software example of the apparatus 1100 for determining a recommendation indicator of resource information described with reference to FIG. 11, and implements the technology described herein in combination with other elements in the electronic device 1210.

Various technologies may be described herein in the general context of software and hardware elements or program modules. The modules include a routine, a program, an object, an element, an assembly, a data structure, and the like that execute a particular task or implement a particular abstract data type. The terms “module”, “function”, and “assembly” used herein refer to software, firmware, hardware, or a combination thereof. The features of the technologies described herein are platform-independent, which means that the technologies may be implemented on various computing platforms having various processors.

The implementation of the described modules and technologies may be stored on a form of computer-readable medium, or transmitted across the form of computer-readable medium. The computer-readable medium may include various media that may be accessed by the electronic device 1210. As an example rather than a limitation, the computer-readable medium may include “a computer-readable storage medium” and “a computer-readable signal medium”.

Contrary to simple signal transmission, a carrier wave, or a signal, the “computer-readable storage medium” refers to a medium and/or a device that can store information permanently, and/or a tangible storage device. Therefore, the computer-readable storage medium refers to a non-signal bearing medium. The computer-readable storage medium includes hardware such as volatile and nonvolatile media, removable and non-removable media, and/or storage devices implemented by using a method or technology suitable for storage of information (such as a computer-readable instruction, a data structure, a program module, a logic element/circuit or other data). An example of the computer-readable storage medium may include, but is not limited to, a RAM, a ROM, an electrically erasable programmable ROM (EEPROM), a flash memory or another memory technology, a CD-ROM, a digital versatile disk (DVD) or another optical storage apparatus, a hard disk, a cassette tape, a magnetic tape, a magnetic disk storage apparatus or another magnetic storage device, or another storage device, a tangible medium, or a product suitable for storing expected information and accessible by a computer.

The “computer-readable signal medium” refers to a signal bearing medium configured to transmit an instruction to hardware of the electronic device 1210, for example, through a network. A signal medium may typically embody the computer-readable instruction, the data structure, the program module, or other data in a modulated data signal such as a carrier wave, a data signal, or another transmission mechanism. The signal medium further includes any information transmission medium. The term “modulated data signal” refers to such a signal. One or more features of the signal are set or changed to encode information into the signal. As an example rather than a limitation, a communication medium includes, for example, a wired network or a direct-connected wired medium, and a wireless medium such as an acoustic medium, an RF medium, an infrared medium, and another wireless medium.

As described above, the hardware element 1214 and the computer-readable medium 1212 represent instructions, modules, programmable device logic, and/or fixed device logic implemented in the form of hardware, which may be configured to implement at least some aspects of the technologies described herein in some aspects. A hardware element may include an integrated circuit or a system on chip, the ASIC, a field programmable gate array (FPGA), a complex programmable logic device (CPLD), and another implementation in silicon or an assembly of another hardware device. In such a context, the hardware element may serve as a processing device for performing a program task defined by the instruction, the module, and/or logic embodied by the hardware element, and a hardware device configured to store an instruction for execution, for example, the computer-readable storage medium previously described.

The foregoing combination may also be configured for implementing various technologies and modules described herein. Therefore, the software, the hardware, or the program module, and another program module may be implemented as one or more instructions and/or logics on a form of computer-readable storage medium and/or embodied by one or more hardware elements 1214. The electronic device 1210 may be configured to implement specific instructions and/or functions corresponding to software and/or hardware modules. Therefore, for example, through use of the computer-readable storage medium and/or the hardware element 1214 of the processing system, a module may be implemented at least partially in hardware as a module executable by the electronic device 1210 as software. The instructions and/or functions may be executed/operated by one or more products (for example, one or more electronic devices 1210 and/or processing systems 1211) to implement the technologies, modules, and examples described herein.

In various implementations, the electronic device 1210 may adopt various different configurations. For example, the electronic device 1210 may be implemented as a computer-type device including a personal computer, a desktop computer, a multi-screen computer, a laptop computer, a netbook, and the like. The electronic device 1210 may further be implemented as a mobile apparatus-type device including mobile devices including a mobile phone, a portable music player, a portable game device, a tablet computer, a multi-screen computer, and the like. The electronic device 1210 may further be implemented as a television-type device, which includes a device having or connected to a large screen in a casual viewing environment. The devices include a television, a set-top box, a game console, and the like.

The technologies described herein may be supported by the various configurations of the electronic device 1210, and are not limited to specific examples of the technologies described herein. The functions may further be implemented in whole or in part on the “cloud” 1220 by using a distributed system such as a platform 1222 described below. The cloud 1220 includes and/or represents the platform 1222 configured for a resource 1224. The platform 1222 abstracts underlying functions of hardware (for example, a server) and software resources of the cloud 1220. The resource 1224 may include other applications and/or data that may be used during execution of computer processing on a server remote from the electronic device 1210. The resource 1224 may further include services provided through the Internet and/or through a subscriber network such as a cellular or Wi-Fi network.

The platform 1222 may abstract resources and functions to connect the electronic device 1210 to another electronic device. The platform 1222 may further be configured to abstract a hierarchy of resources to provide a hierarchy of corresponding levels of encountered requirements for the resource 1224 implemented through the platform 1222. Therefore, in an interconnected device aspect, the implementation of the functions described herein may be distributed throughout a system 1200. For example, the functions may be partially implemented on the electronic device 1210 and through the platform 1222 that abstracts the functions of the cloud 1220.

For the sake of clarity, the aspects of this disclosure are described based on different functional units. However, it is to be apparent that functionality of each functional unit may be implemented in a single unit, implemented in a plurality of units, or implemented as a part of another functional unit without departing from this application. For example, the functionality described as being performed by a single unit may be performed by a plurality of different units. Therefore, a reference to a specific functional unit is only regarded as a reference to an appropriate unit configured to provide the described functionality, rather than indicative of a strict logical or physical structure or organization. Therefore, this application may be implemented in a single unit, or may be physically and functionally distributed between different units and circuits.

Although the terms such as “first”, “second”, and “third” in this specification may be configured for describing various devices, elements, components, or parts, the devices, elements, components, or parts are not to be limited by such terms. The terms are only configured for distinguishing one device, element, component, or part from another device, element, component, or part.

Although this disclosure has been described in combination with some aspects, this disclosure is not intended to be limited to the specific forms set forth herein. On the contrary, the scope of this disclosure is limited only by the appended claims. Additionally, although individual features may be included in different claims, the combinations, which may be advantageously combined, are included in different claims, and do not imply features, are not feasible and/or advantageous. An order of the features in the claims does not imply any specific order in which the features need to be operated. In addition, in the claims, the word “comprising” does not exclude another element, and the term “a” or “one” does not exclude a plurality.

What is claimed is:

1. A method for determining recommendation indicators, the method comprising:
constructing a first bipartite graph based on interaction feature data that indicate interactions between a plurality of objects and a plurality of pieces of resource information, the first bipartite graph including (i) a plurality of graph nodes and (ii) a positive connecting edge, the plurality of graph nodes including an object node for each of the plurality of objects and a resource information node for each of the plurality of pieces of the resource information, the positive connecting edge being between a first object node of the plurality of object nodes and a first resource information node of the plurality of resource information nodes, the positive connecting edge indicating a positive feedback feature between a first object of the plurality of objects that corresponds to the first object node and a first piece of resource information of the plurality of pieces of resource information that corresponds to the first resource information node;
constructing a second bipartite graph based on the interaction feature data, the second bipartite graph including the plurality of graph nodes and a negative connecting edge between a second object node of the plurality of object nodes and a second resource information node of the plurality of resource information nodes, the negative connecting edge indicating a negative feedback feature between a second object of the plurality of objects that corresponds to the second object node and a second piece of resource information of the plurality of pieces of resource information corresponding to the second resource information node;
determining comprehensive embedding vector representations of the plurality of graph nodes based on the first bipartite graph and the second bipartite graph; and
determining the recommendation indicator for each of the plurality of pieces of resource information with respect to each of the plurality of objects based on the comprehensive embedding vector representation of the object node corresponding to the respective object and the comprehensive embedding vector representation of the resource information node corresponding to the respective piece of resource information.

2. The method according to claim 1, wherein the determining the comprehensive embedding vector representations comprises:
for each of the plurality of graph nodes,
determining a first embedding vector representation and a second embedding vector representation of the respective graph node; and
combining the first embedding vector representation and the second embedding vector representation of the respective graph node to obtain the comprehensive embedding vector representation of the respective graph node.

3. The method according to claim 2, wherein the determining the first embedding vector representation and the second embedding vector representation of the respective graph node comprises:
invoking, based on the first bipartite graph and the second bipartite graph, a graph neural network model to determine the first embedding vector representation and the second embedding vector representation of the respective graph node.

4. The method according to claim 3, wherein the graph neural network model includes a first graph neural network submodel and a second graph neural network submodel, and the invoking comprises:
invoking, based on the first bipartite graph, the first graph neural network submodel to determine the first embedding vector representation of the respective graph node; and
invoking, based on the second bipartite graph and the first embedding vector representation of the respective graph node, the second graph neural network submodel to determine the second embedding vector representation of the respective graph node.

5. The method according to claim 4, wherein the first graph neural network submodel includes K graph convolutional layers, where K is an integer greater than 1, and the invoking the first graph neural network submodel comprises:
obtaining a first adjacency matrix of the first bipartite graph and a first initial embedding vector representation for each graph node;
for each k from 1 to K:
when k is equal to 1, generating a first intermediate embedding vector representation of the respective graph node via graph convolution based on the first adjacency matrix and the first initial embedding vector representation; and
when k is greater than 1, generating the first intermediate embedding vector representation of the respective graph node via the graph convolution based on the first adjacency matrix and the first intermediate embedding vector representation output by a (k−1)^{th} graph convolutional layer;
collecting first intermediate embedding vector representations from the K graph convolutional layers; and
determining the first embedding vector representation of the respective graph node based on an average value of K first intermediate embedding vector representations and the first initial embedding vector representation.

6. The method according to claim 4, wherein the second graph neural network submodel includes a multilayer perceptron (MLP), and the invoking, based on the second bipartite graph and the first embedding vector representation of each graph node comprises:
obtaining a second adjacency matrix of the second bipartite graph; and
invoking the MLP based on the second adjacency matrix and the first embedding vector representation of the respective graph node to determine the second embedding vector representation of the respective graph node.

7. The method according to claim 3, wherein the graph neural network model is trained with at least the positive connecting edge of the first bipartite graph and at least the negative connecting edge of the second bipartite graph, until a loss function of the graph neural network model reaches a minimum value.

8. The method according to claim 7, wherein the loss function of the graph neural network model includes at least one of a Bayesian personalized ranking (BPR) loss function and a cosine loss function.

9. The method according to claim 8, wherein the loss function further includes a regularization term including an L2 norm of one or more parameters of the graph neural network model.

10. The method according to claim 1, wherein the determining the recommendation indicator for each of the plurality of pieces of resource information comprises:
determining an inner product of the comprehensive embedding vector representation of each of the plurality of object nodes and the comprehensive embedding vector representation of each of the plurality of resource information nodes; and
determining the recommendation indicator for each of the plurality of pieces of resource information with respect to each of the plurality of objects based on the inner product of the comprehensive embedding vector representation of the respective object node and the comprehensive embedding vector representation of the respective resource information node.

11. An apparatus, comprising:
processing circuitry configured to:
construct a first bipartite graph based on interaction feature data that indicate interactions between a plurality of objects and a plurality of pieces of resource information, the first bipartite graph including (i) a plurality of graph nodes and (ii) a positive connecting edge, the plurality of graph nodes including an object node for each of the plurality of objects and a resource information node for each of the plurality of pieces of the resource information, the positive connecting edge being between a first object node of the plurality of object nodes and a first resource information node of the plurality of resource information nodes, the positive connecting edge indicating a positive feedback feature between a first object of the plurality of objects that corresponds to the first object node and a first piece of resource information of the plurality of pieces of resource information that corresponds to the first resource information node;
construct a second bipartite graph based on the interaction feature data, the second bipartite graph including the plurality of graph nodes and a negative connecting edge between a second object node of the plurality of object nodes and a second resource information node of the plurality of resource information nodes, the negative connecting edge indicating a negative feedback feature between a second object of the plurality of objects that corresponds to the second object node and a second piece of resource information of the plurality of pieces of resource information corresponding to the second resource information node;
determine comprehensive embedding vector representations of the plurality of graph nodes based on the first bipartite graph and the second bipartite graph; and
determine a recommendation indicator for each of the plurality of pieces of resource information with respect to each of the plurality of objects based on the comprehensive embedding vector representation of the object node corresponding to the respective object and the comprehensive embedding vector representation of the resource information node corresponding to the respective piece of resource information.

12. The apparatus according to claim 11, wherein the processing circuitry is configured to:
for each of the plurality of graph nodes,
determine a first embedding vector representation and a second embedding vector representation of the respective graph node; and
combine the first embedding vector representation and the second embedding vector representation of the respective graph node to obtain the comprehensive embedding vector representation of the respective graph node.

13. The apparatus according to claim 12, wherein the processing circuitry is configured to:
invoke, based on the first bipartite graph and the second bipartite graph, a graph neural network model to determine the first embedding vector representation and the second embedding vector representation of the respective graph node.

14. The apparatus according to claim 13, wherein the graph neural network model includes a first graph neural network submodel and a second graph neural network submodel, and wherein the processing circuitry is configured to:
invoke, based on the first bipartite graph, the first graph neural network submodel to determine the first embedding vector representation of the respective graph node; and
invoke, based on the second bipartite graph and the first embedding vector representation of the respective graph node, the second graph neural network submodel to determine the second embedding vector representation of the respective graph node.

15. The apparatus according to claim 14, wherein the first graph neural network submodel includes K graph convolutional layers, where K is an integer greater than 1, and the processing circuitry is configured to:
obtain a first adjacency matrix of the first bipartite graph and a first initial embedding vector representation for each graph node;
for each k from 1 to K:
when k is equal to 1, generate a first intermediate embedding vector representation of the respective graph node via graph convolution based on the first adjacency matrix and the first initial embedding vector representation; and
when k is greater than 1, generate the first intermediate embedding vector representation of the respective graph node via the graph convolution based on the first adjacency matrix and the first intermediate embedding vector representation output by a (k−1)^{th} graph convolutional layer;
collect first intermediate embedding vector representations from the K graph convolutional layers; and
determine the first embedding vector representation of the respective graph node based on an average value of K first intermediate embedding vector representations and the first initial embedding vector representation.

16. The apparatus according to claim 14, wherein the second graph neural network submodel includes a multilayer perceptron (MLP), and wherein the processing circuitry is configured to:
obtain a second adjacency matrix of the second bipartite graph; and
invoke the MLP based on the second adjacency matrix and the first embedding vector representation of the respective graph node to determine the second embedding vector representation of the respective graph node.

17. The apparatus according to claim 13, wherein the graph neural network model is trained with at least the positive connecting edge of the first bipartite graph and at least the negative connecting edge of the second bipartite graph, until a loss function of the graph neural network model reaches a minimum value.

18. The apparatus according to claim 17, wherein the loss function of the graph neural network model includes at least one of a Bayesian personalized ranking (BPR) loss function and a cosine loss function.

19. The apparatus according to claim 18, wherein the loss function further includes a regularization term including an L2 norm of one or more parameters of the graph neural network model.

20. A non-transitory computer-readable storage medium storing instructions which, when executed by a processor, cause the processor to perform:
constructing a first bipartite graph based on interaction feature data that indicate interactions between a plurality of objects and a plurality of pieces of resource information, the first bipartite graph including (i) a plurality of graph nodes and (ii) a positive connecting edge, the plurality of graph nodes including an object node for each of the plurality of objects and a resource information node for each of the plurality of pieces of the resource information, the positive connecting edge being between a first object node of the plurality of object nodes and a first resource information node of the plurality of resource information nodes, the positive connecting edge indicating a positive feedback feature between a first object of the plurality of objects that corresponds to the first object node and a first piece of resource information of the plurality of pieces of resource information that corresponds to the first resource information node;
constructing a second bipartite graph based on the interaction feature data, the second bipartite graph including the plurality of graph nodes and a negative connecting edge between a second object node of the plurality of object nodes and a second resource information node of the plurality of resource information nodes, the negative connecting edge indicating a negative feedback feature between a second object of the plurality of objects that corresponds to the second object node and a second piece of resource information of the plurality of pieces of resource information corresponding to the second resource information node;
determining comprehensive embedding vector representations of the plurality of graph nodes based on the first bipartite graph and the second bipartite graph; and
determining a recommendation indicator for each of the plurality of pieces of resource information with respect to each of the plurality of objects based on the comprehensive embedding vector representation of the object node corresponding to the respective object and the comprehensive embedding vector representation of the resource information node corresponding to the respective piece of resource information.
